(19) United States
(12) Patent Application Publication
(10) Pub. No.: US 2021/0246020 A1
(43) Pub. Date: Aug. 12, 2021

(54) CHEMICAL METHOD OF IN-SITU ON-DEMAND HYDROGEN GAS GENERATION

(71) Applicant: Xnrgi, Inc., San Jose, CA (US)

(72) Inventors: Saroj Kumar Sahu, San Jose, CA (US); Gerard Christopher D'Couto, Edmonds, WA (US)

(73) Assignee: Xnrgi, Inc., San Jose, CA (US)

(21) Appl. No.: 16/788,256

(22) Filed: Feb. 11, 2020

(51) Int. Cl. C01B 3/06; H01M 8/065; B01J 8/00; B01J 8/02

(52) U.S. Cl. CPC C01B 3/065; H01M 8/065; B01J 8/0015; C01B 2203/1205; B01J 8/02; C01B 2203/02; B01J 8/008

(57) ABSTRACT

A method uses a chemical system to generate hydrogen gas. The chemistry involves a two-step reaction. In the first step, an alkaline hydride reacts with water to produce a hydroxide and hydrogen. In the second step, the hydroxide reacts with aluminum to produce even more hydrogen. The fuel is composed out of a mixture of powders of the alkaline hydride and aluminum. The fuel is encapsulated in a water soluble capsule for easy dispensing and protection against short time exposure to moisture. For large scale systems, the fuel is mixed with a low hydrophilicity ionic liquid to make it into a slurry that can be dispensed into a reaction chamber. The generation system comprises a tank, a pump, a first tube, a second tube, one or more capsules, a tank sensor assembly, and a processing system. The method comprises the steps of dispensing the capsules or the slurry in the tank; supplying water to the tank; and collecting hydrogen gas from the tank. After supplying water to the tank, the two reaction steps, being safe and controllable, facilitating hydrolysis reaction of metal and metal salts, are carried out. The produced hydrogen may be used in a fuel cell or a biomedical application.

### CROSS-REFERENCE TO RELATED APPLICATIONS

The disclosure made in the U.S. Pat. No. 9,985,308 to Iftime, et al., and the disclosure made in International Patent Application No. WO2003016165A1 to Scott, et al. are hereby incorporated by reference.

### FIELD OF THE INVENTION

This invention relates generally to a method of using a system for generating hydrogen gas. More particularly, the present invention relates to a chemical method of in-situ on-demand hydrogen gas generation.

### BACKGROUND OF THE INVENTION

Fuel cells usually use Hydrogen gas as the fuel. Hydrogen is usually stored at high pressure. Transportation of hydrogen with pipelines or tankers is expensive and unsafe. Logistics of hydrogen availability is considered to be a bottle-neck against wide-spread deployment of fuel cells.

This invention provides a method to produce hydrogen in-situ and on-demand near the fuel cell. A set of chemical reactions happen when water is dripped on a mixture of solid chemical compounds and hydrogen is released as a result. Hydrogen thus produced can be pressurized, if necessary, and provided to fuel cells. The rate of water-drip can be regulated so as to control the H₂ generation rate.

Generation of Hydrogen by reaction of alkali metals and their hydrides with water is known in chemistry text books.

U.S. Pat. No. 9,985,308 to Iftime, et al. uses encapsulants enclosing metal hydrides for controlling the rate of reaction.

In one example, Group I alkali metals, such as Lithium, produce 1 mole of H₂ for every 2 moles of metal used.

2Li+2H₂O→2LiOH+H₂ (1)

In another example, Group II alkali metals, such as Calcium, produce 1 mole of H₂ for every 1 moles of metal used.

Ca+2H₂O→Ca(OH)₂+H₂ (2)

Group I alkali metal hydrides, such as LiH, produce 1 mole of H₂ for every 1 mole of metal hydride used.

LiH+H₂O→LiOH+H₂ (3)

Group II alkali metal hydrides, such as CaH₂, produce 2 moles of H₂ for every 1 mole of metal hydride used. See equation 4 below.

In the examples above, 0.5 to 2 moles of H₂ is produced for each mole of alkali metal or alkali metal hydride used.

The energy density—defined as the ratio of weight of hydrogen generated to the moles of the solid reactant is of primary concern in many applications, such as military, mobile applications, and biomedical applications.

The present disclosure provides a chemistry that produces more than 2 moles of H₂ per mole of metal or metal hydride.

### SUMMARY OF THE INVENTION

A method of using a system for generation of hydrogen gas is disclosed. The system comprises a tank, a pump, a first tube, a second tube, one or more capsules, a tank sensor assembly, and a processing system. The method comprises the steps of preparing one or more capsules; placing the one or more capsules in the tank; supplying a wet reactant to the tank; and collecting hydrogen gas from the tank.

A Stoichiometric ratio of Aluminum powder and Ca(OH)₂ powder are mixed and put inside a capsule. The capsules are made out of water-soluble materials. Water-soluble materials are widely available from pharmaceutical industry. In a predetermined size of a capsule, x grams of Aluminum powder and y grams of Ca(OH)₂ ground granules are placed in capsules. The stoichiometric ratio of x:y is determined by the chemical reaction in Equation 6. The ratio may be shifted left or right depending on the desired rate of reaction. The capsules are placed in a tank or a bottle. Water is injected with a metered pump into the tank or bottle.

In another implementation, the dry reactant powders are mixed with an ionic liquid with limited hydrophilicity to the consistency of a slurry. When water is added to such slurry, the film of such ionic liquid controls the amount of water that transgresses to the dry reactants, thus controlling the rate of reaction. One example of such limited hydrophilicity ionic liquids is the class of ionic liquids containing the cation bis(trifluoromethanesulfonyl)imide [(CF₃SO₂)₂N]⁻ otherwise known in the field as TFSI or NTF₂, are abbreviations for the cation. Many amine-based anions can be attached to this cation that serve the purpose of limited hydrophilicity. One such example is BMIM, which has a chemical formula: 1-Butyl-3-methylimidazolium. The full ionic liquid is therefore BMIM-NTF₂.

The generated H₂ is optionally provided to a fuel cell, which generates electrical energy by taking oxygen from the atmosphere and combining it with hydrogen electrochemically. The generated H₂ is optionally provided to skin or digestive track of a patient.

If the generated hydrogen is used in a fuel cell, it is important to control the rate of generation of hydrogen so that the fuel cell is not starved for or has an excess of hydrogen gas when it is serving its electrical load. In one example, generation of hydrogen is controlled in the following manner:

The flow of water activates the reaction. Firstly, the polymeric wall of the capsule material dissolves in water, exposing the solid reactants to water, allowing the hydrogen gas generation to take place.

The reactions are exo-thermic. Unless the rate of water input is controlled, the system may heat up to boiling and create a hazardous condition. Besides, the copious amount of hydrogen gas produced by unregulated addition of water may not be immediately consumed by the fuel cell, resulting in surplus hydrogen gas escaping through the fuel cell output port—thus resulting in wastage of the fuel.

On the other hand, the fuel cell usually services an electrical load. If the load requirement is lower than the power than can be generated by the produced Hydrogen, then again, the surplus H₂ will flow out of the fuel cell output port, resulting in wastage of fuel.

Therefore, the process of addition of water must be controlled as a function of the reactant temperature (Th), and the Fuel cell load voltage (V) and Fuel cell load current (I).

### BRIEF DESCRIPTION OF THE DRAWINGS

FIG. 1 shows a system for generating hydrogen gas in examples of the present disclosure.

FIG. 2 shows a portion of a fuel cell in examples of the present disclosure.

FIG. 3 shows a portion of a processing system in examples of the present disclosure.

FIG. 4 shows a capsule in examples of the present disclosure.

FIG. 5 shows another capsule in examples of the present disclosure.

FIG. 6 is a flowchart of a process using a system to generate hydrogen gas in examples of the present disclosure.

### DETAILED DESCRIPTION OF THE INVENTION

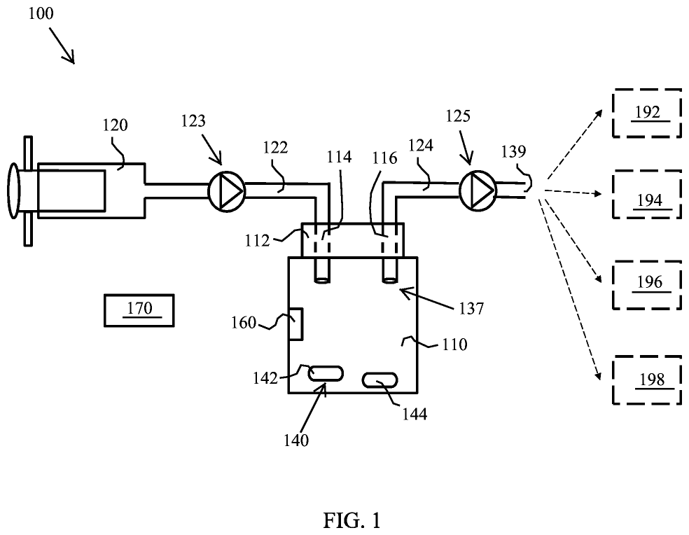

FIG. 1 shows a system 100 for generating hydrogen gas in examples of the present disclosure. The system 100 comprises a tank 110, a pump 120, a first tube 122, a second tube 124, one or more capsules 140, a tank sensor assembly 160, and a processing system 170. The tank 110 comprises a cover 112 comprising an inlet hole 114 and an outlet hole 116. The first tube 122 connects the pump 120 to the inlet hole 114 of the cover 112 of the tank 110. The second tube 124 comprises a first end 137 and a second end 139. The first end 137 is attached to the outlet hole 116 of the cover 112 of the tank 110. In one example, the pump 120 is a syringe pump.

In examples of the present disclosure, a one-way valve 123 is disposed at an upstream location of the inlet hole 114 so that wet reactant flows through the one-way valve 123, through the inlet hole 114, then entering the tank 110. The one-way valve 123 prevents fluid or air flowing from the tank 110 to the pump 120.

In examples of the present disclosure, a one-way valve 125 is disposed at an upstream location of the second end 139 of the second tube 124 so that generated hydrogen from the tank 110 flows through the one-way valve 125 to the second end 139 of the second tube 124. The one-way valve 125 prevents fluid or air flowing from the second end 139 of the second tube 124 to the tank 110.

In examples of the present disclosure, the tank sensor assembly 160 is disposed in the tank 110. The tank sensor assembly 160 comprises a first temperature sensor measuring the temperature in the tank 110, a second temperature sensor measuring the temperature of the first dry reactant, a third temperature sensor measuring the temperature of the second dry reactant, a flow sensor to measure a flow rate of the incoming wet reactant entering the tank 110, and a gas sensor to measure the amount of hydrogen gas generated.

The second end 139 of the second tube 124 optionally deliver hydrogen gas to a compressor 192, skin 194 of a patient, a digestive track 196 of a patient, or a fuel cell 198. Because of being optional, the compressor 192, the skin 194 of a patient, the digestive track 196 of a patient, and the fuel cell 198 are shown in dashed lines. The compressor 192 increases the pressure of the hydrogen gas.

The one or more capsules 140 contains predetermined dry reactants. In examples of the present disclosure, the one or more capsules 140 are water-soluble. In one example, the one or more capsules 140 comprises a first capsule 142 and a second capsule 144. The first capsule 142 contains calcium hydride. The second capsule 144 contains aluminum.

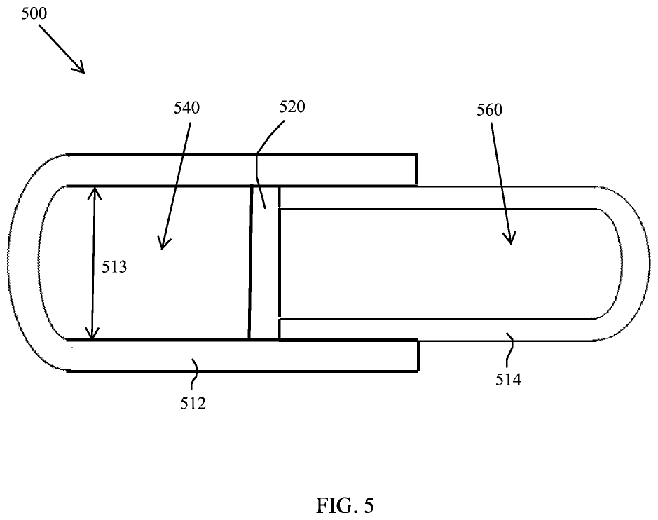

In another example, the one or more capsules 140 comprises a first capsule 500 of FIG. 5. The first capsule 500 comprises a separator 520, a first compartment 540, and a second compartment 560. The second compartment 560 is separated from the first compartment 540 by the separator 520. The first compartment 540 contains calcium hydride. The second compartment 560 contains aluminum.

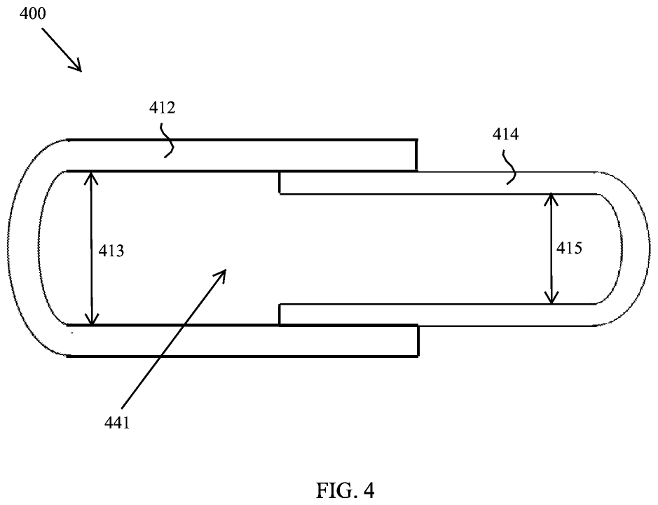

In still another example, the one or more capsules 140 comprises a first capsule 400 of FIG. 4. The first capsule 400 contains a mixture of calcium hydride and aluminum.

In examples of the present disclosure, powdered calcium hydride is thoroughly mixed with powdered Aluminum in weight ratio of 42:65 to create a fuel mixture. The stoichiometric ratio according to Equation 6 is 42:54. The surplus amount of Aluminum is provided to increase the rate of reaction of the 2^{nd} step described as Equation 5. Average size of calcium hydroxide powder is 10 micron. Average size of aluminum powder is 1 micron. The advantage of smaller powder size is to increase overall powder surface areas, with a controlled overall powder weight, for reaction.

In one embodiment of the present disclosure, the fuel mixture is used as is in the reaction chamber with water.

In another embodiment of the current disclosure, the fuel mixture is further mixed with the ionic liquid BMIM-NTF₂ so as to form a slurry. The weight ratio of calcium hydroxide:aluminum:BMIM-NTF₂ is 42:65:25. The slurry is to be dispensed under a dynamic pressure into the reaction chamber for reaction with water.

In yet another embodiment of the current disclosure, the fuel mixture is encapsulated in water soluble capsules, to be used in the reaction chamber for reaction with water.

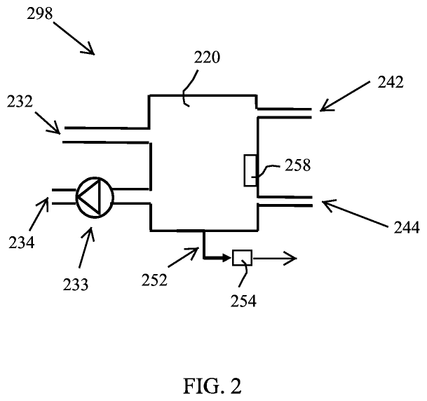

FIG. 2 shows a portion of the fuel cell 198 of FIG. 1 in examples of the present disclosure. The fuel cell 198 comprises a reactor vessel 298 comprising a vessel 220, a hydrogen inlet 232, a hydrogen outlet 234, an oxygen inlet 242, an oxygen outlet 244, a cable 252, a current meter 254, and a fuel cell sensor assembly 258. In examples of the present disclosure, a one-way valve 233 is disposed at an upstream location of the hydrogen outlet 234 so that excessive hydrogen gas flows through the one-way valve 233 and then flows out of the hydrogen outlet 234. The one-way valve 233 prevents external air flowing through the hydrogen outlet 234 than into the vessel 220.

In examples of the present disclosure, the hydrogen inlet 232 connects to the second end 139 of the second tube 124 of the system 100 of FIG. 1. The oxygen inlet 242 is configured to receive oxygen from atmosphere. The cable 252 is for outputting electrical current measured by the current meter 254.

In examples of the present disclosure, the fuel cell sensor assembly 258 is disposed in the vessel 220. The fuel cell sensor assembly 258 comprises a temperature sensor to measure the temperature in the vessel 220, a plurality of gas flow sensors to measure a flow rate of the incoming hydrogen, a flow rate of the outgoing hydrogen, a flow rate of the incoming oxygen, and a flow rate of the outgoing oxygen.

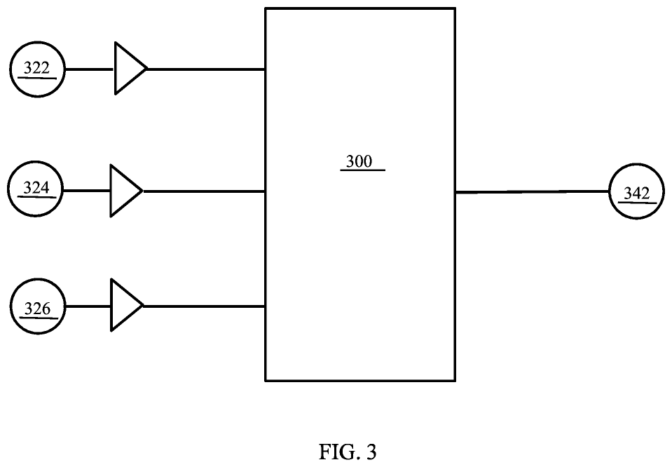

FIG. 3 shows a portion of the processing system 170 of FIG. 1 in examples of the present disclosure. The processing system 170 of FIG. 1 comprises a processor 300. In one example, the processor 300 is a microprocessor. The processor 300 receives signals from tank sensor assembly 160 of FIG. 1, fuel cell sensor assembly 258 of FIG. 2, and current meter 254 of FIG. 3 through wired or wireless communication. The processor 300 sends signals to an actuator or a valve of the pump 120 through wired or wireless communication.

In the implementation of the control of the generation of H₂ and the fuel cell application, electrical measurements of “Th value” 322, “V value” 324, and “I value” 326 are conditioned as necessary and then fed to into the processor 300. Here, “Th value” 322 is a temperature measured in the tank 110 of FIG. 1. “I value” 326 is the current measured by the current meter 254 of FIG. 2. “V value” 324 is determined by the “I value” 326 multiplied by predetermined resistance. An algorithm that optimizes the H₂ utilization by the fuel cell determines a condition 342 whether the water pump should be turned ON or OFF as a function of the three parameters “Th value” 322, “V value” 324 and “I value” 326. In this implementation the “V value” represents the voltage of a single fuel cell. In stacks having multiple (N) fuel cells in series, the “V value” will be the stack voltage normalized by “N”, as is well known to practitioners in the field of fuel cells.

An example of the logic implementation when the ambient temperature is 25 degrees C. is:

If (Th<35 degrees C. AND V<0.8 Volt): Turn Pump ON

If (Th>60 degrees C. OR V>1.1): Turn Pump OFF

If (V×I)>Pₘₐₓ: Turn Pump OFF

Here, Pₘₐₓ is the maximum allowable power.

In examples of the present disclosure, the condition 342 is used to control the flow rate of the incoming wet reactant into the tank 110 of FIG. 1. The flow rate of the incoming wet reactant into the tank 110 of FIG. 1 is a function of a temperature of the calcium hydride, a temperature of the aluminum, load voltage of the fuel cell, load current of the fuel cell, and a generation rate of the hydrogen gas. In examples of the present disclosure, the flow rate of the water is under a proportional-integral-derivative (PID) control.

FIG. 4 shows a capsule 400 in examples of the present disclosure. The capsule 400 comprises a first member 412 and a second member 414. An inner diameter 413 of the first member 412 is larger than an inner diameter 415 of the second member 414. The capsule 400 has a single compartment 441. In one example, the single compartment 441 receives a single type of dry reactant. In one example, the single compartment 441 receives a mixture of one or more types of dry reactants.

FIG. 5 shows a capsule 500 in examples of the present disclosure. The capsule 500 comprises a separator 520, a first member 512, a second member 514, a first compartment 540, and a second compartment 560. The second compartment 560 is separated from the first compartment 540 by the separator 520. In examples of the present disclosure, the first compartment 540 contains a first type of dry reactant. The second compartment 560 contains a second type of dry reactant. In examples of the present disclosure, an outer diameter of the separator 520 under a no-load condition (before inserting into the first member 512) is in a range from 1.03 times to 1.10 times of the inner diameter 513 of the first member 512. Therefore, the separator 520 is inserted into the first member 512 under a press-fitted condition.

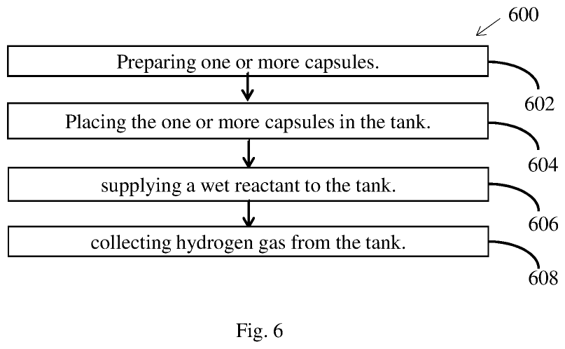

FIG. 6 is a flowchart of a process 600 using the system 100 of FIG. 1 to generate hydrogen gas in examples of the present disclosure. The process 600 may start from block 602.

In block 602, one or more capsules 140 of FIG. 1 are prepared. The one or more capsules 140 contain dry reactants. In one example, the one or more capsules 140 contain calcium hydride and aluminum. If the capsule 500 of FIG. 5 is used, the one or more capsules comprise a single capsule 500. The first compartment 540 is filled with the calcium hydride. The separator 520 is inserted into the first member 512. The second compartment 560 is filled with aluminum. The, the second compartment 560 is engaged with the first compartment 540. Block 602 may be followed by block 604.

In block 604, the one or more capsules 140 of FIG. 1, containing calcium hydride and aluminum, are placed in the tank 110. Block 604 may be followed by block 606.

In block 606, a wet reactant is supplied to the tank 110 of FIG. 1. In one example, the wet reactant is water.

In examples of the present disclosure, the reaction process consists of a two-step reaction of mixture of an alkaline (Group II) metal hydride and a Group III metal, such as aluminum. All solid reactants are preferably in powder form, reacting with water.

In examples of the present disclosure, the alkaline metal hydride is Calcium Hydride. Other alkaline and alkali metals whose hydrides that will also work include Lithium, Sodium, Magnesium, and Potassium.

In the first reaction step, CaH₂ reacts with water to generate H₂ gas and Calcium Hydroxide Ca(OH)₂. Ca(OH)₂ is soluble in water and makes the water alkaline. In the second reaction step, Ca(OH)₂ reacts with aluminum powder to produce even more H₂ gas.

1st reaction step: CaH₂+2H₂O→Ca(OH)₂+²H₂ (4)

2nd reaction step: Ca(OH)₂+2Al+4H₂O→Ca(AlH₂O₃)₂+3H₂ (5)

The resultant chemical reaction is:

CaH₂+2Al+6H₂O→Ca(AlH₂O₃)₂+5H₂ (6)

Thus, for each mole of Calcium Hydride, 5 moles of Hydrogen are generated. This is far higher than 0.5-2 Moles of H₂ per mole of metal or hydride. The addition of Aluminum power is considered a small cost to pay for this additional hydrogen yield, since Aluminum is far cheaper than hydrides. Block 606 may be followed by block 608.

In block 608, the generated hydrogen gas is collected through the second tube 124 of FIG. 1.

Those of ordinary skill in the art may recognize that modifications of the embodiments disclosed herein are possible. For example, a number of capsules in the tank 110 may vary. Other modifications may occur to those of ordinary skill in this art, and all such modifications are deemed to fall within the purview of the present invention, as defined by the claims.

1. A method of generating hydrogen gas in a two-step reaction, the method comprising:
a first step comprising a metal hydride reacting with water producing a hydroxide and hydrogen gas; and
a second step comprising the hydroxide produced in the first step reacting with aluminum powder producing additional hydrogen gas.

2. The method of claim 1, wherein the metal hydride and the aluminum powder are mixed in a weight ratio in a range from 0.25 to 4 so as to create a fuel mixture.

3. The method of claim 2, wherein the metal hydride is a hydride of an alkaline (Group II) or alkali (Group I) metal.

4. The method of claim 3, wherein the hydride is calcium hydride.

5. The method of claim 4, wherein an average size of power of the hydride is less than 100 microns.

6. The method of claim 2, wherein an average size of the aluminum powder is less than 100 microns.

7. The method of claim 2, wherein the fuel mixture is encapsulated in a water-soluble capsule.

8. The method of claim 2, wherein the fuel mixture is slurried with an ionic liquid with limited hydrophilicity; and wherein a weight ratio of the fuel mixture to the ionic liquid is in a range from 0.1 to 10.

9. The method of claim 8, wherein the ionic liquid retains a range of 100 to 10,000 ppm of water at 25 degrees Centigrade and 80% relative humidity (RH).

10. The method of claim 8, wherein a cation of the ionic liquid is bis(trifluoromethanesulfonyl)imide.

11. The method of claim 8, wherein an anion of the ionic liquid is 1-Butyl-3-methylimidazolium.

12. A method of using a hydrogen gas generation system, the hydrogen gas generation system comprising:
a tank comprising
an inlet hole; and
an outlet hole;
a pump;
a first tube connecting the pump to the inlet hole of the tank;
a second tube comprising
a first end attached to the outlet hole of the tank; and
a second end; and
fuel mixture generating hydrogen gas while contacting a wet reactant;
the method comprising the steps of
placing the fuel mixture in the tank;
supplying the wet reactant from the pump through the first tube to the tank; and
collecting hydrogen gas from the tank through the second tube.

13. The method of claim 12, wherein the fuel mixture comprising dry reactants calcium hydride and aluminum; and wherein the wet reactant is water.

14. The method of claim 13, wherein a stoichiometric ratio of the calcium hydride to the aluminum is in a range from 0.25 to 4.

15. The method of claim 13, wherein the fuel mixture is encapsulated in one or more capsules that are water-soluble.

16. The method of claim 13, wherein an encapsulation of the fuel mixture comprises
a first set of capsules containing the calcium hydride; and
a second set of capsules containing the aluminum.

17. The method of claim 13, wherein an encapsulation of the fuel mixture comprises
a first capsule comprising
a separator;
a first compartment; and
a second compartment separated from the first compartment by the separator;
wherein the first compartment containing the calcium hydride; and
wherein the second compartment containing the aluminum.

18. The method of claim 13, wherein an encapsulation of the fuel mixture comprises a first capsule containing the calcium hydride and the aluminum.

19. The method of claim 13, wherein the calcium hydride is mixed with a first predetermined hydrophilicity ionic liquid so as to form a first slurry and wherein the aluminum is mixed with a second predetermined hydrophilicity ionic liquid so as to form a second slurry.

20. The method of claim 19, wherein a first weight ratio of the first predetermined hydrophilicity ionic liquid to the first slurry is less than twenty percent and wherein a second weight ratio of the second predetermined hydrophilicity ionic liquid to the second slurry is less than twenty percent.

21. The method of claim 13, wherein the system further comprises a fuel cell connecting to the second end of the second tube.

22. The method of claim 21, wherein the fuel cell comprises a reactor vessel comprising
a vessel;
a hydrogen inlet connecting to the second end of the second tube;
a hydrogen outlet;
an oxygen inlet configured to receive oxygen from atmosphere;
an oxygen outlet; and
a cable for outputting electrical current.

23. The method of claim 21, wherein the hydrogen gas generation system further comprises a microprocessor controlling a flow rate of the water.

24. The method of claim 23, wherein the flow rate of the water is a function of
a temperature of the calcium hydride;
a temperature of the aluminum;
load voltage of the fuel cell;
load current of the fuel cell; and
a generation rate of the hydrogen gas.

25. The method of claim 24, wherein the flow rate of the water is under a proportional-integral-derivative (PID) control.

26. The method of claim 13, wherein the pump is a syringe pump.

27. The method of claim 13, wherein the second end of the second tube is configured to deliver the hydrogen gas to skin or a digestive track of a patient.

28. The method of claim 13, wherein the first tube comprises a first one-way valve; and the second tube comprises a second one-way valve.
